(19) United States
(12) Patent Application Publication
(10) Pub. No.: US 2014/0074878 A1
(43) Pub. Date: Mar. 13, 2014

(54) SPREADSHEET SCHEMA EXTRACTION

(71) Applicants: Mihaela A. Bornea, White Plains, NY (US); Songyun Duan, Pleasantville, NY (US); Achille B. Fokoue-Nkoutche, White Plains, NY (US); Anastasios Kementsietsidis, New York, NY (US); Kavitha Srinivas, Rye, NY (US); Michael J. Ward, New Haven, CT (US)

(72) Inventors: Mihaela A. Bornea, White Plains, NY (US); Songyun Duan, Pleasantville, NY (US); Achille B. Fokoue-Nkoutche, White Plains, NY (US); Anastasios Kementsietsidis, New York, NY (US); Kavitha Srinivas, Rye, NY (US); Michael J. Ward, New Haven, CT (US)

(73) Assignee: INTERNATIONAL BUSINESS MACHINES COPORATION, Armonk, NY (US)

(21) Appl. No.: 13/617,322

(22) Filed: Sep. 14, 2012

Related U.S. Application Data
(63) Continuation of application No. 13/611,258, filed on Sep. 12, 2012.

(51) Int. Cl. G06F 17/30

(52) U.S. Cl. 707/769; 707/E17.014; 707/E17.044

(57) ABSTRACT

Aspects of the present invention provide a tool for extracting schema from a spreadsheet. In an embodiment, a set of data that is stored in an uncataloged tabular format, such as a spreadsheet, is retrieved. The structure of the retrieved set of data is surveyed to determine the dataset schema thereof. Then, data elements within the dataset schema are analyzed to obtain information regarding the data elements. Based on dataset schema and the element information, an interface can be constructed that allows remote access to the set of data.

### CROSS-REFERENCE TO RELATED APPLICATIONS

This application is a continuation of currently pending U.S. patent application Ser. No. 13/611,258 filed on Sep. 12, 2012. The application identified above is incorporated herein by reference in its entirety for all that it contains in order to provide continuity of disclosure.

### TECHNICAL FIELD

The subject matter of this invention relates generally to data retrieval. More specifically, aspects of the present invention provide a tool for extracting schema from spreadsheets.

### BACKGROUND

As information technology has improved in popularity, its usefulness as a way to store and retrieve data has become widely appreciated. Computers offer the ability to store data utilizing a fraction of the physical space required by paper-based storage solutions. In addition, access to the computer-based data can significantly reduce the retrieval time for the data.

To facilitate computer-based storage, several different types of storage paradigms have been developed. As can be appreciated, these paradigms can differ significantly with respect to characteristics such as simplicity of use and availability. For example, database-type storage solutions can offer interlinked data and/or or indexing that facilitate accessing and/or interpreting data. However, the time and knowledge needed to initialize the database-type storage solutions may be prohibitive for some users. In contrast, simple table-based data storage solutions, such as spreadsheets, provide a medium with greater ease of use for less sophisticated users, but this can sometimes come at the expense of data accessibility.

### SUMMARY

The inventors of the present invention have discovered that the current way of accessing data in table-based storage solutions such as spreadsheets can be improved. Specifically, the flexibility that allows a user to utilize a spreadsheet in many different ways can provide difficulties in attempting to access the data stored therein without human intervention. For example, because users are not required to define fields for data, to use standardized data constructs, and/or to provide a data definition that can be accessed by others, it becomes difficult for someone accessing the data to interpret the data that has been retrieved. To this extent, there is no way, given a set of unknown spreadsheets, to query the spreadsheets for a desired dataset. Furthermore, even though two different spreadsheets may have related information, a spreadsheet created by one individual may have a different format, different data types, different naming conventions, etc., that make using the spreadsheets in conjunction with one another a challenge.

In general, aspects of the present invention provide a tool for extracting schema from a spreadsheet. In an embodiment, a set of data that is stored in an uncataloged tabular format, such as a spreadsheet, is retrieved. The structure of the retrieved set of data is surveyed to determine the dataset schema thereof. Then, data elements within the dataset schema are analyzed to obtain information regarding the data elements. Based on dataset schema and the element information, an interface can be constructed that allows remote access to the set of data.

A first aspect of the invention provides a method for extracting spreadsheet schema, comprising: retrieving a set of data stored in an uncataloged tabular format; surveying a structure of the set of data to determine a dataset schema of the set of data; analyzing data elements within the dataset schema to obtain element information; and constructing an interface using the dataset schema and the element information for remotely accessing the set of data.

A second aspect of the invention provides a system for extracting spreadsheet schema, comprising at least one computer device that performs a method, comprising: retrieving a set of data stored in an uncataloged tabular format; surveying a structure of the set of data to determine a dataset schema of the set of data; analyzing data elements within the dataset schema to obtain element information; and constructing an interface using the dataset schema and the element information for remotely accessing the set of data.

A third aspect of the invention provides a computer program product stored on a computer readable storage medium, which, when executed performs a method for extracting spreadsheet schema, comprising: retrieving a set of data stored in an uncataloged tabular format; surveying a structure of the set of data to determine a dataset schema of the set of data; analyzing data elements within the dataset schema to obtain element information; and constructing an interface using the dataset schema and the element information for remotely accessing the set of data.

A fourth aspect of the invention provides a method for deploying an application for extracting spreadsheet schema, comprising: providing a computer infrastructure being operable to: retrieve a set of data stored in an uncataloged tabular format; survey a structure of the set of data to determine a dataset schema of the set of data; analyze data elements within the dataset schema to obtain element information; and construct an interface using the dataset schema and the element information for remotely accessing the set of data.

Still yet, any of the components of the present invention could be deployed, managed, serviced, etc., by a service provider who offers to implement the teachings of this invention in a computer system.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system according to embodiments of the present invention.

FIG. 2 shows a tabular dataset according to embodiments of the invention.

FIG. 3 shows an illustration of a use of a line-by-line scan on a tabular dataset according to embodiments of the invention.

FIG. 4 shows an illustration of a further use of a line-by-line scan on a tabular dataset according to embodiments of the invention.

FIG. 5 shows a flow diagram showing subsequent access to the tabular dataset according to embodiments of the invention.

FIG. 6 shows an example flow diagram according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, aspects of the present invention provide a tool for extracting schema from a spreadsheet. In an embodiment, a set of data that is stored in an uncataloged tabular format, such as a spreadsheet, is retrieved. The structure of the retrieved set of data is surveyed to determine the dataset schema thereof. Then, data elements within the dataset schema are analyzed to obtain information regarding the data elements. Based on dataset schema and the element information, an interface can be constructed that allows remote access to the set of data.

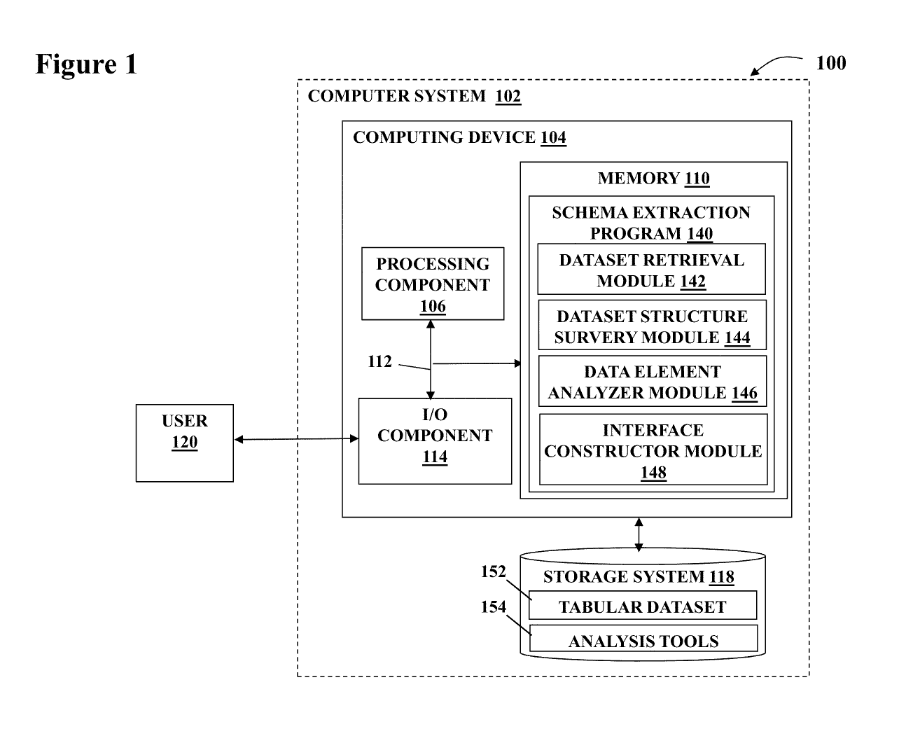

Turning to the drawings, FIG. 1 shows an illustrative environment 100 for extracting spreadsheet schema. To this extent, environment 100 includes a computer system 102 that can perform a process described herein in order to extract spreadsheet schema. In particular, computer system 102 is shown including a computing device 104 that includes a schema extraction program 140, which makes computing device 104 operable to extract spreadsheet schema by performing a process described herein.

Computing device 104 is shown including a processing component 106 (e.g., one or more processors), a memory 110, a storage system 118 (e.g., a storage hierarchy), an input/output (I/O) component 114 (e.g., one or more I/O interfaces and/or devices), and a communications pathway 112. In general, processing component 106 executes program code, such as schema extraction program 140, which is at least partially fixed in memory 110. To this extent, processing component 106 may comprise a single processing unit, or be distributed across one or more processing units in one or more locations.

Memory 110 also can include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may comprise any known type of temporary or permanent data storage media, including magnetic media, optical media, random access memory (RAM), read-only memory (ROM), a data cache, a data object, etc. Moreover, similar to processing component 116, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O component 114 can comprise one or more human I/O devices, which enable a human user 120 to interact with computer system 102 and/or one or more communications devices to enable a system user 120 to communicate with computer system 102 using any type of communications link.

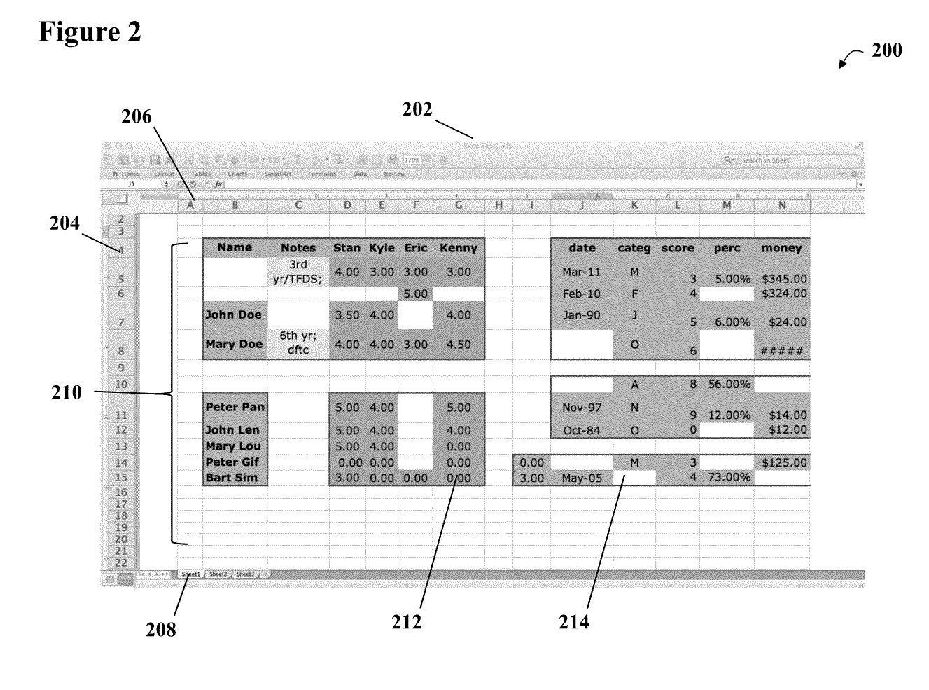

To this extent, schema extraction program 140 can manage a set of interfaces (e.g., graphical user interface(s), application program interface, and/or the like) that enable human and/or system users 120 to interact with schema extraction program 140. Users 120 could include system administrators and/or clients who need to query and/or provide query and/or other access to a tabular dataset 200 (FIG. 2), among others. Further, schema extraction program 140 can manage (e.g., store, retrieve, create, manipulate, organize, present, etc.) the data in storage system 118, including, but not limited to a tabular dataset 152 and/or analysis tools 154, using any solution.

In any event, computer system 102 can comprise one or more computing devices 104 (e.g., general purpose computing articles of manufacture) capable of executing program code, such as schema extraction program 140, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, schema extraction program 140 can be embodied as any combination of system software and/or application software. In any event, the technical effect of computer system 102 is to provide processing instructions to computing device 104 in order to remediate a migration-related failure.

Further, schema extraction program 140 can be implemented using a set of modules 142-148. In this case, a module 142-148 can enable computer system 102 to perform a set of tasks used by schema extraction program 140, and can be separately developed and/or implemented apart from other portions of schema extraction program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 can have only a portion of schema extraction program 140 fixed thereon (e.g., one or more modules 142-148). However, it is understood that computer system 102 and schema extraction program 140 are only representative of various possible equivalent computer systems that may perform a process described herein. To this extent, in other embodiments, the functionality provided by computer system 102 and schema extraction program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, schema extraction program 140 enables computer system 102 to extract spreadsheet schema. To this extent, schema extraction program 140 is shown including a dataset retrieval module 142, a dataset structure survey module 144, a data element analyzer module 146, and an interface constructor module 148.

Computer system 102, executing dataset retrieval module 142, retrieves a tabular dataset 152, where tabular dataset 152 is a set of data stored in a tabular format. Retrieval of tabular dataset 152 can be performed using any solution now known or later developed, including, but not limited from retrieval from a storage system 118, over a local area or wide area network, or the like, or creation by user 120. In any case, tabular dataset 152, as retrieved by dataset retrieval module 142 can be an uncataloged set of data. Specifically, tabular dataset 152 does not require the inclusion and/or association of interlinking data, indices, metadata or other external links into the data, interfaces, or other access tools in order to be utilized by schema extraction program 140.

Referring now to FIG. 2, a tabular dataset 200 according to embodiments of the invention is shown. Tabular dataset 200 can be in the form of a spreadsheet 202, as shown in FIG. 2, or alternatively, can be contained in any other type of application that can represent a set of data in a tabular format, including but not limited to a word processing application, a presentation application, an illustration application or the like. In any case, as shown, tabular dataset 200 includes a set of data elements 210 which can include data, such as data element 212 or can have no data, as does data element 214. Data elements 210 can be addressed by a set of row indicators 204 and/or a set of column indicators 206, using any solution. In addition, tabular dataset 200 can be displayed on a single sheet in the application or, in the alternative multiple sheets 208 can be used to represent all of the data.

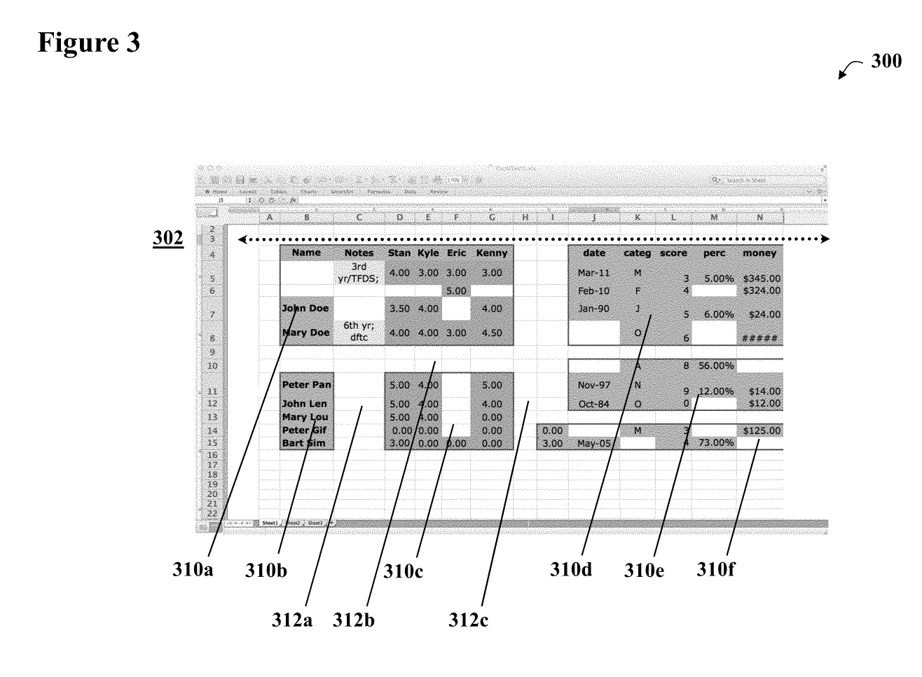

In any event, once tabular dataset 200 has been retrieved, dataset structure survey module 144, as executed by computer system 102, can survey a structure of tabular dataset 200. This survey can be performed based only on the data that is found within tabular dataset 200, and thus without external access aids. For example, one or more rectangular areas within tabular dataset 200 can be identified. Each identified rectangular area can be an area within tabular dataset 200 that has contiguous data, that is, data elements 210 that contain data. In order to identify these rectangular areas, a line-by-line scan of tabular dataset 200 can be performed. This scan can be performed, similar to a computer graphics scan, by treating tabular dataset 200 as a two dimensional array and using a scan-line inspired algorithm to determine non-intersecting rectangles. Such a scan-line inspired algorithm can work as follows: scan-line 302 (FIG. 3) can iterates over the rows (the algorithm also works by scanning columns) of tabular dataset 200. As a first step it can identify and skip all empty rows in the tabular dataset.

Even though empty rows (columns) may not require further processing, empty rows (columns) can be particularly important as they can be used to identify the boundaries between the rectangular data-containing areas. If an empty row is identified, then the algorithm can conclude that any future rectangles will not intersect with any rectangles identified thus far (due to the empty row) and therefore the algorithm can mark all previously identified rectangles as complete. For non-empty rows, whenever a non-empty cell in the tabular dataset is identified, it can be used to define a new rectangle initially only containing the single identified non-empty cell. Then, the algorithm can test whether there is any adjacent rectangle (in the same row) that is adjacent to the newly created rectangle, and if this is the case the two rectangles can be merged into one (thereby extending the boundary of the previously identified rectangle).

The algorithm can also consider the case in which a rectangle is adjacent or overlaps with a previously identified rectangle in one of the previous rows. This consideration can involve at least four different cases to identify overlaps, including: (a) whether a previously identified rectangle is adjacent on the upper row of the current rectangle with the left or right column of the other rectangle within the boundaries of the current rectangle; (b) whether a previously identified rectangle is adjacent on the lower row of the current rectangle with the left or right column of the other rectangle within the boundaries of the current rectangle; (c) whether a previously identified rectangle is adjacent on the left column of this rectangle with the upper or lower row of the other rectangle within the boundaries of the current rectangle; and/or (d) whether the previously identified rectangle is adjacent on the right column of this rectangle with the upper or lower row of the other rectangle within the boundaries of the current rectangle. If any of these four cases applies, the two rectangles can be merged into one. The algorithm terminates when all the rows (and columns) in the tabular dataset are processed.

Turning now to FIG. 3, an illustration of the use of a line-by-line scan on tabular dataset 300 is shown. As illustrated, a scan-line 302 is scanning tabular dataset 300 on a row-by-row basis. It should, however, be recognized that scan-line 302 could scan tabular dataset 300 on a column-by-column basis additionally or in the alternative. Further, scan-line 302 could perform the scan beginning with the first row or column in tabular dataset 300 and progress through the rows and/or columns in order, or, in the alternative could use an algorithm that begins in another location and/or scans in a different order. Still further, a single scan-line 302 or, in the alternative, a plurality of scan-lines 302 could be utilized to perform the line-by-line scan.

In any event, as shown in FIG. 3, line-by-line scan as performed using scan-line 302 has detected six rectangular areas 310a-f. Each rectangular area 310a-f has contiguous data within its boundaries, however, as can be seen, there can be data locations within a rectangular area 310a-f that have no data. Rather, the line-by-line scan can set a border for a particular rectangular area 310a-f upon scan-line 302 encountering a line of data locations 312a-c having no data that is directly adjacent to the rectangular area. So for example, as illustrated in FIG. 3, rectangular area 310c is bordered by line of blank data locations 312a to the left, line of blank data locations 312b above, and line of blank data locations 312c to the right.

The information returned by line-by-line scan performed using scan-line 302 can also be used to determine type information for the data elements within a particular rectangular area 310a-f. For example, a set of known data types can be created based on the data identified in the tabular dataset and their correspondence with well-known data types used in computing environments (e.g. strings, integers, floats, dates, times). Popular tabular datasets (e.g. commercially available spreadsheets) often have data types that are used specifically with a particular product, and these can used as an initial type system. Alternatively, data types can be imported. These known data types can be imported from any source, including, but not limited to from previous analysis of other spreadsheets. Data elements within the rectangular area 310a-f can then be compared with these data types to attempt to determine whether the data types correspond.

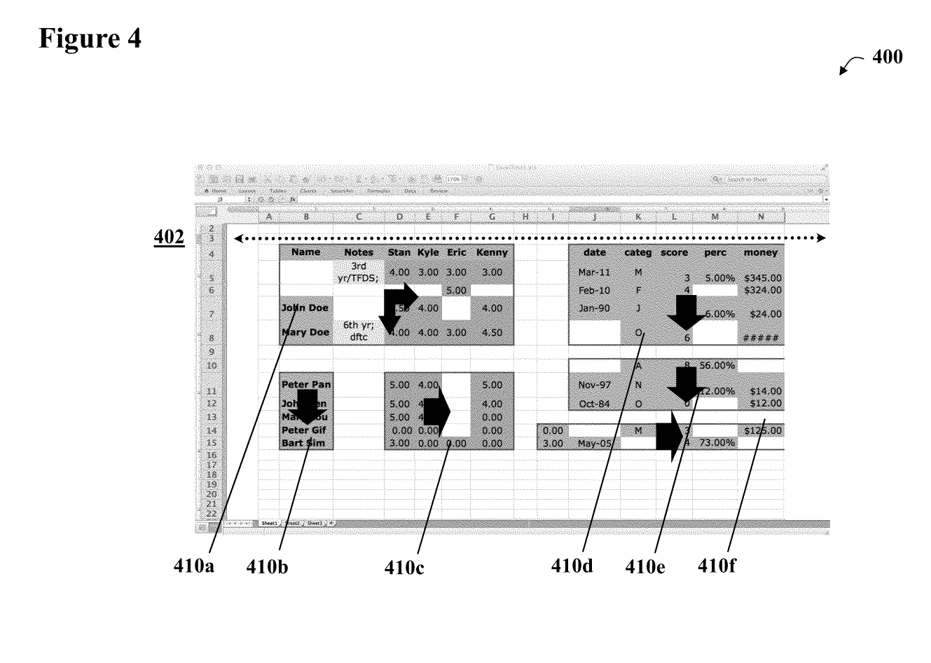

Turning now to FIG. 4, an illustration of a further use of a line-by-line scan on a tabular dataset 400 is shown. Specifically, the information returned by scan-line 402 can be used to determine a logical orientation within a particular rectangular area 410a-f. For example, a linear array of data locations, such as a row or column within a rectangular area 410a-f can be analyzed after scan-line 402 has scanned the data locations. The analysis of the linear array can determine whether the data elements within the linear array have corresponding data types. If such a correspondence is found, the data within the rectangular area 410a-f can be presumed to be logically oriented in the same direction as the linear array. This presumption can be strengthened if, for example, a number of linear arrays having corresponding data types with the same logical orientation can be found within the rectangular area 410a-f. This can be further borne out if linear arrays in a different direction have different data types. As shown in FIG. 3, rectangular areas 410c and 410f have been determined as having a horizontal orientation (e.g., the elements are logically oriented along the rows), rectangular areas 410b, 410d and 410e have been determined as having a vertical orientation (e.g., the elements are logically oriented along the columns) and rectangular area 410a has been determined as having a bi-directional orientation (e.g., the elements are logically oriented along both the rows and the columns).

The information returned by line-by-line scan performed using scan-line 402 can also be used to determine a set of header identifiers within a particular rectangular area 410a-f. For example, contents of data locations within rectangular area 410a-f, particularly data locations adjacent to the border, can be analyzed to determine whether they contain textual data. If these data locations are found to contain textual data, the data can be analyzed to determine whether it corresponds to common values for known header identifiers. For example, values such as “name”, “date”, “amount”, “cost”, and the like, if found in these data locations could be determined as being header identifiers. In an embodiment, the textual data can be compared with an external source, such as a dictionary, an ontology, and/or the like. Further, if multiple linear arrays of header identifiers are found in a single rectangular area 410a-f, a type hierarchy can be created by relying on the merging attributes of the data locations within the rectangular area 410a-f.

Referring back to FIG. 1 in conjunction with FIG. 3, data element analyzer module 146, as executed by computer system 102, can analyze data elements within the dataset schema returned by dataset structure survey module 144 to obtain further element information that pertains to the specific data elements located therein. For example, the dataset schema can be analyzed to determine which data elements in the dataset schema contain raw data. In this example, raw data can be distinguished from compilation data. For example, many tabular datasets 300 contain data elements which combine other data elements in some way. Examples of such compilation data include formulas which can provide a summation, multiplication, percentage, concatenation and/or the like, of data elements within the dataset. Data element analyzer module 146 can distinguish between raw data and compilation. Then the limits of the data elements that contain raw data can be identified. For example, an extension of the algorithm can identify rectangles so that rectangles are not extended to areas that contain compilation data. Then, for all practical purposes, a data element containing compilation data would be treated like empty data element for the purposes of the tabular data-set processing.

Referring again to FIG. 1, interface constructor module 148, as executed by computer system 102, can construct an interface through which tabular dataset 152 can be remotely accessed. This access can include the ability to “open” a connection, “close” a connection, “get” the metadata, “query” a tabular dataset, and/or the like in much the same way in which one would “open” a connection, “close” a connection, “get” the metadata, “query” a remote data source, and/or the like (e.g. using a relational database, a remote web source and/or the like). This construction can be performed using the dataset schema returned by dataset structure survey module 144 and element information data element analyzer module 146, which can take the form of metadata or, in the alternative, can assume any other form that is adapted to convey information about data.

As such, the interface constructed by interface constructor module 148 provides users 120 a tool to access and understand the data within tabular dataset 152 that would otherwise be unavailable. Further, this data could be combined with data from other such datasets 152 and/or with more structured data such as from one or more structured databases, thus providing greater accessibility to existing data. In this way, a user 120 can issue a structured query without knowledge of the data in the tabular dataset 152 and receive in return data elements in the tabular dataset 152 that satisfy the structured query. Further, the evaluating of such a structured query with respect to the tabular dataset can return a trigger interface to iterate over the data elements that satisfy the structured query This trigger interface could offer the ability to iterate one-by-one over all the elements of the tabular dataset that satisfy a query. In more detail, the interface could provide methods to the user to return the size of the answer set to the query (say, a size( ) method), as well as methods to test whether the answer set is empty (say, a isEmpty( ) method), and also methods to get the first answer in the answer set (say, a getFirst( ) method). Also, the user could be able to use a next( ) method to get the next answer after the current one, until all the answers in the answer set have been processed. In this manner, and with such an interface, the user will be able to get all the answers to a query, starting from the first

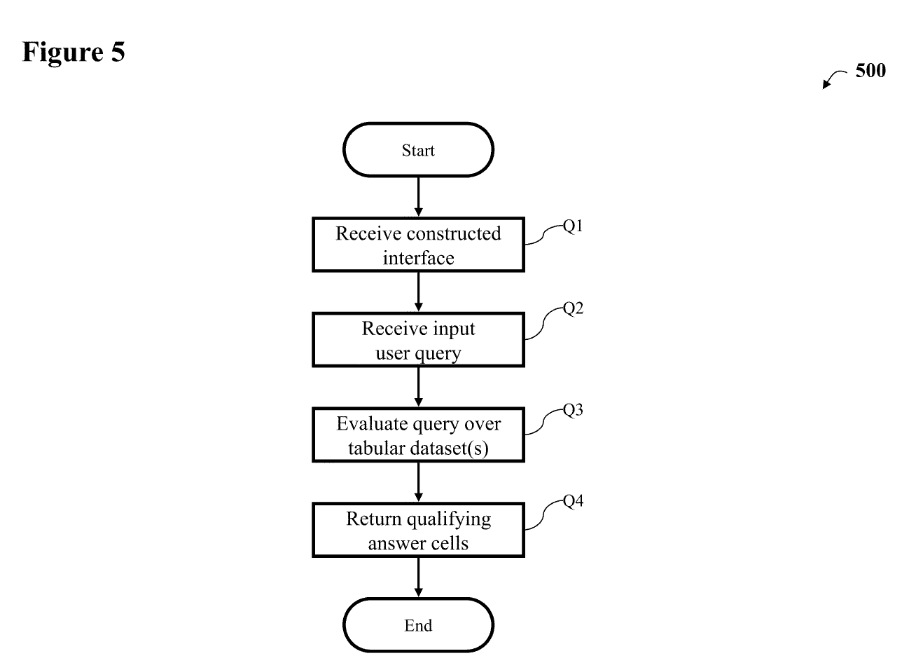

Turning now to FIG. 5, a flow diagram showing subsequent access to the tabular dataset according to embodiments of the invention is shown. As illustrated in FIG. 5 in conjunction with FIG. 1, in Q1, the interface constructed by interface constructor module 148 is received. In Q2, a structured query is received from user 120. Structured query is a request for data elements in a dataset, such as tabular dataset 152. To this extent, structured query may be written in a structured query language, such as SQL or the like. In S3, the query received from user 120 is evaluated over tabular dataset 152. This evaluation can be in isolation, in conjunction with other tabular datasets 152 and/or in conjunction with other data, such as that located in a structured database. In any case, in evaluating the query over tabular dataset 152, the constructed interface is used to indicate the schema of the tabular dataset 152. This evaluation can also return a trigger interface to iterate over the data elements that satisfy the structured query. Thus, in S4, qualifying answer cells, e.g., data elements in the tabular dataset 152 that satisfy the structured query can be returned to user 120.

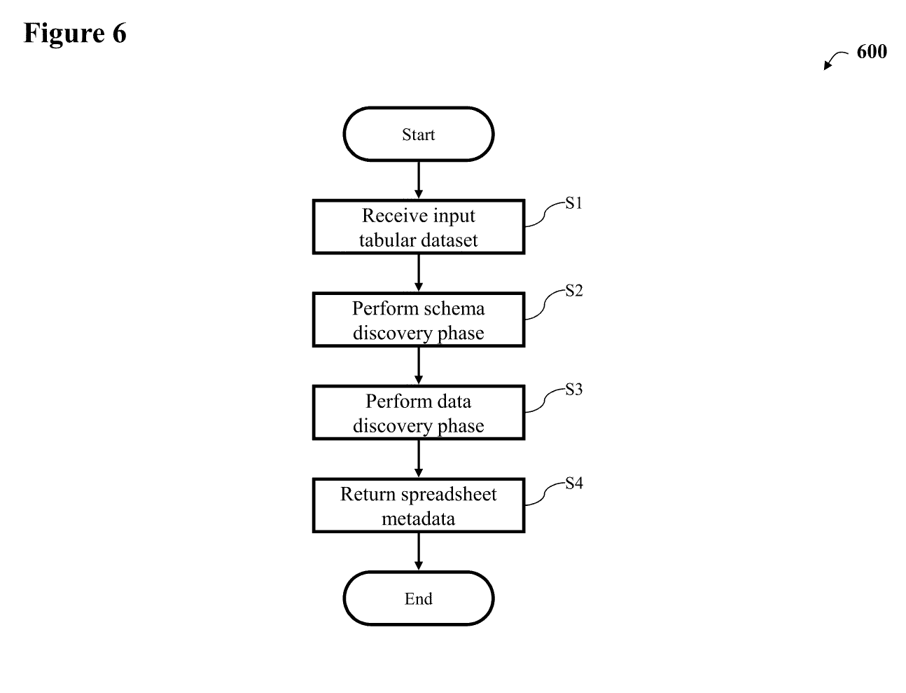

Turning now to FIG. 6, an example flow diagram according to embodiments of the invention is shown. As illustrated in FIG. 6 in conjunction with FIG. 1, in S1, dataset retrieval module 142, as executed by computer system 102, retrieves a set of data (tabular dataset 152) stored in an uncataloged tabular format. This uncataloged tabular format can be that of a spreadsheet or any other format that can be used for storing a tabular dataset 152. In S2, dataset structure survey module 144, as executed by computer system 102, surveys a structure of the set of data to determine a dataset schema of the set of data. This dataset schema could include determining of rectangular areas 310a-f, determining border areas, determining logical orientations, determining header identifiers and/or determining type information for elements in the tabular dataset 152. In S3, dataset element analyzer module 146, as executed by computer system 102, analyzes data elements with the dataset schema to obtain data element information. This element information could include, among other things, limits within the dataset that delimit raw data from compilation data. In S4, interface constructor module 148, as executed by computer system 102, constructs an interface using the dataset schema and the element information that allows the tabular dataset 152 to be remotely accessed.

While shown and described herein as a method and system for extracting spreadsheet schema, it is understood that aspects of the invention further provide various alternative embodiments. For example, in one embodiment, the invention provides a computer program fixed in at least one computer-readable medium, which when executed, enables a computer system to extract spreadsheet schema. To this extent, the computer-readable medium includes program code, such as schema extraction program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as schema extraction program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for remediating a migration-related failure. In this case, a computer system, such as computer system 120 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, if and where used herein do not denote any order, quantity, or importance, but rather are used to distinguish one element from another, and the terms “a” and “an” herein do not denote a limitation of quantity, but rather denote the presence of at least one of the referenced item. The modifier “approximately”, where used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A system for extracting spreadsheet schema, comprising at least one computer device that performs a method, comprising:
retrieving a set of data stored in an uncataloged tabular format;
surveying a structure of the set of data to determine a dataset schema of the set of data;
analyzing data elements within the dataset schema to obtain element information; and
constructing an interface using the dataset schema and the element information for remotely accessing the set of data.

2. The system of claim 1, wherein the tabular format includes a spreadsheet.

3. The system of claim 1, wherein the surveying further comprises:
identifying a rectangular area in the set of data having contiguous data;
determining a logical orientation of data elements that are within the rectangular area;
determining a set of header identifiers for the data elements within the rectangular area; and
determining data type information for the data elements.

4. The system of claim 3, wherein the identifying further comprises:
performing a line-by-line scan of the set of data; and
setting a border of the rectangular area upon encountering a line having no data directly adjacent to the contiguous data.

5. The system of claim 4, wherein the determining of the set of header identifiers further comprises:
analyzing contents of data locations that are adjacent the border;
determining whether a set of the data locations contain textual data; and
comparing the textual data with known header identifiers to determine whether the textual data includes a set of header identifiers for the rectangular area.

6. The system of claim 5, wherein the comparing compares the textual data with at least one of an external dictionary or an ontology.

7. The system of claim 3, wherein determining of the logical orientation further comprises:
analyzing a linear array of data locations within the rectangular area;
determining whether data elements within the linear array have corresponding data types; and
identifying whether the data elements are logically stored horizontally, vertically or bi-directionally based on the determining.

8. The system of claim 3, wherein the determining of type information further comprises:
importing a set of known data types gathered from previous analysis of other spreadsheets; and
comparing types of data elements in the rectangular area with the set of known data types.

9. The system of claim 1, wherein the analyzing of the data elements further comprises:
distinguishing, for each of the data elements, whether the data element contains raw data or compilation data; and
identifying limits within the rectangular area in which the data elements which have raw data are contained.

10. The system of claim 1, further comprising:
receiving a structured query from a user;
evaluating the structured query with respect to the set of data based on the constructed interface; and
returning data elements in the set of data that satisfy the structured query.

11. The system of claim 10, wherein the evaluating of the structured query with respect to the set of data returns a trigger interface to iterate over the data elements that satisfy the structured query.

12. A computer program product stored on a computer readable storage medium, which, when executed performs a method for extracting spreadsheet schema, comprising:
retrieving a set of data stored in an uncataloged tabular format;
surveying a structure of the set of data to determine a dataset schema of the set of data;
analyzing data elements within the dataset schema to obtain element information; and
constructing an interface using the dataset schema and the element information for remotely accessing the set of data.

13. The system of claim 12, wherein the tabular format includes a spreadsheet.

14. The system of claim 12, wherein the surveying further comprises:
identifying a rectangular area in the set of data having contiguous data;
determining a logical orientation of data elements that are within the rectangular area;
determining a set of header identifiers for the data elements within the rectangular area; and
determining data type information for the data elements.

15. The system of claim 14, wherein the identifying further comprises:
performing a line-by-line scan of the set of data; and
setting a border of the rectangular area upon encountering a line having no data directly adjacent to the contiguous data.

16. The system of claim 15, wherein the determining of the set of header identifiers further comprises:
analyzing contents of data locations that are adjacent the border;
determining whether a set of the data locations contain textual data; and
comparing the textual data with known header identifiers to determine whether the textual data includes a set of header identifiers for the rectangular area.

17. The system of claim 16, wherein the comparing compares the textual data with at least one of an external dictionary or an ontology.

18. The system of claim 14, wherein determining of the logical orientation further comprises:
analyzing a linear array of data locations within the rectangular area;
determining whether data elements within the linear array have corresponding data types; and
identifying whether the data elements are logically stored horizontally, vertically or bi-directionally based on the determining.

19. The system of claim 14, wherein the determining of type information further comprises:
importing a set of known data types gathered from previous analysis of other spreadsheets; and
comparing types of data elements in the rectangular area with the set of known data types.

20. The system of claim 12, wherein the analyzing of the data elements further comprises:
distinguishing, for each of the data elements, whether the data element contains raw data or compilation data; and
identifying limits within the rectangular area in which the data elements which have raw data are contained.

21. The system of claim 12, further comprising:
receiving a structured query from a user;
evaluating the structured query with respect to the set of data based on the constructed interface; and
returning data elements in the set of data that satisfy the structured query.

22. The system of claim 21, wherein the evaluating of the structured query with respect to the set of data returns a trigger interface to iterate over the data elements that satisfy the structured query.
